(19) United States
(12) Patent Application Publication
(10) Pub. No.: US 2008/0068339 A1
(43) Pub. Date: Mar. 20, 2008

(54) ELECTRONIC DEVICE WITH KEYPAD ASSEMBLY

(76) Inventor: Henrik Jensfelt, Limhamn (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/532,568

(22) Filed: Sep. 18, 2006

(51) Int. Cl. G09G 5/00

(52) U.S. Cl. 345/169

(57) ABSTRACT

An electronic device includes a keypad assembly. The keypad assembly has a plurality of alphanumeric keys for user entry of alphanumeric characters and a navigation input device for user entry of plural directional inputs. The navigation input device and the alphanumeric keys are commingled such that an area consumed by at least one of the alphanumeric keys intersects with an area consumed by the navigation input device.

### TECHNICAL FIELD OF THE INVENTION

The present invention relates generally to an electronic device, such as a mobile telephone. More particularly, the present invention relates to an electronic device with a user input device in the form of a keypad assembly that combines alphanumeric keys and a multi-directional navigation input device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices are becoming increasingly diverse. To name a few examples, many electronic devices have cameras, text messaging capability, Internet browsing capability, electronic mail capability, video playback capability, audio playback capability, image display capability and handsfree headset interfaces.

In order to use the various features of electronic devices, electronic devices typically include user input devices. For example, many mobile telephones include alphanumeric keys for inputting text data, such as telephone numbers, names, text message bodies, and so forth. The collection of alphanumeric keys conventionally includes twelve buttons. Ten of those buttons are associated with the numbers zero through nine with the button for numbers two through nine also being associated with letters of the English alphabet or some other alphabet. The two remaining buttons are typically associated with the star symbol and the pound symbol, respectively. In some other mobile telephones, a larger set of alphanumeric keys may be present. For instance, some mobile telephones have a full QUERTY keyboard where each letter of the English alphabet has an associated key. Some of the QUERTY keys also may be associated with numbers and/or the star and pound symbols, or the numbers and symbols may be associated with additional keys.

Mobile telephones also tend to have dedicated function keys that are associated with a specific task, such as launching a menu, answering a call, ending a call, controlling a camera, and so forth. Some function keys may have multiple uses that depend on an operational mode of the mobile telephone.

In addition, a navigation input device may be present. Navigation devices are often used by the user to input direction so as to navigate through menus, play games, move a cursor and so forth. The navigation input device often takes the form of a rocker switch or a dome switch. Conventional navigation input devices allow the user to specify a direction from plural directions for which the navigation input device will accept an input, such as up, down, left and right. Some navigation devices include a ring or plate that may rock in four or more directions to accept corresponding directional inputs. A select button may be present in the center of the ring that, when downwardly depressed, results in the selection a highlighted menu item or the execution of a function associated with the select button in the current operational mode of the mobile telephone.

The forgoing collection of buttons and user input devices consumes a considerable amount of space on a surface of the mobile telephone. The presence of alphanumeric keys, function keys and a navigation input device reduces the available space for other items, such as a display, unless the overall size of the mobile telephone is increased.

### SUMMARY

To maximize the available area on an electronic device for a display while providing at least alphanumeric keys and a navigation input device as user input devices, there is a need in the art for a keypad assembly that combines an alphanumeric key(s) and a multi-directional navigation input device. Aspects of the present invention are directed to commingling of one or more alphanumeric keys and a navigation input device such that the alphanumeric keys and the navigation input device overlap on the surface of an electronic device, such as a mobile telephone. In one embodiment, one or more keys are surrounded by a user depressible portion of the navigation input device.

According to one aspect of the invention, an electronic device includes a keypad assembly. The keypad assembly has a plurality of alphanumeric keys for user entry of alphanumeric characters; and a navigation input device for user entry of plural directional inputs, the navigation input device and the alphanumeric keys being commingled such that an area consumed by at least one of the alphanumeric keys intersects with an area consumed by the navigation input device.

According to an embodiment of the electronic device, the navigation input device has a user depressible member that is depressible in locations corresponding to the plural directional inputs to accept entry of the directional inputs, and the alphanumeric key is at least partially surrounded by the depressible member.

According to an embodiment of the electronic device, the navigation input device includes an aperture through which the alphanumeric key protrudes.

According to an embodiment of the electronic device, plural alphanumeric keys protrude through corresponding apertures of the depressible member.

According to an embodiment of the electronic device, surface indicia corresponding to the alphanumeric key is disposed on the depressible member.

According to an embodiment of the electronic device, the electronic device is a mobile telephone having a radio circuit to establish a call over a communications network.

According to an embodiment of the electronic device, the keypad assembly further includes a select key for user entry of a select command.

According to an embodiment of the electronic device, the select key is one of a function key or a soft key.

According to an embodiment of the electronic device, the select key is located apart from the navigation input device.

According to an embodiment of the electronic device, the select key is commingled with the navigation input device.

According to an embodiment of the electronic device, the navigation input device is a collection of navigation keys and each navigation key corresponds to one of the directional inputs, and at least some of the navigation keys are interspersed with the alphanumeric keys.

According to another aspect of the invention, an electronic device includes a keypad assembly. The keypad assembly has a navigation input device having a user depressible member that is depressible in a plurality of locations, each location corresponding to a directional input; and plural keys that are at least partially surrounded by the user depressible member so that the keys and the navigation input device are commingled such that an area consumed by the keys intersects with an area consumed by the navigation input device.

According to an embodiment of the electronic device, at least one of the keys is an alphanumeric key.

According to an embodiment of the electronic device, at least on of the keys is a select key.

According to an embodiment of the electronic device, the electronic device is a mobile telephone having a radio circuit to establish a call over a communications network.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention, the mobile telephone including an exemplary keypad assembly according to the present invention;

FIG. 2 is a schematic block diagram of functional components of the mobile telephone of FIG. 1;

FIG. 3 is a schematic diagram of a communications system in which the mobile telephone of FIG. 1 may operate; and

FIG. 4 is a schematic view of a combined alphanumeric key and navigation input device portion of the exemplary keypad assembly of FIG. 1.

### DETAILED DESCRIPTION OF EMBODIMENTS

The present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of appropriate electronic equipment, examples of which include a media player, a gaming device and a computer.

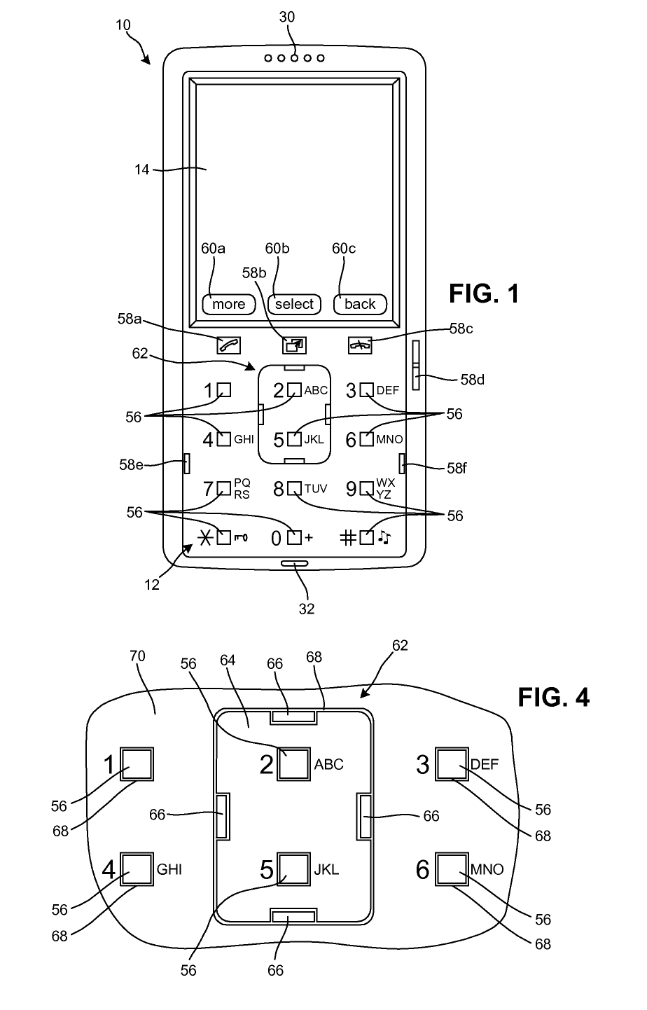

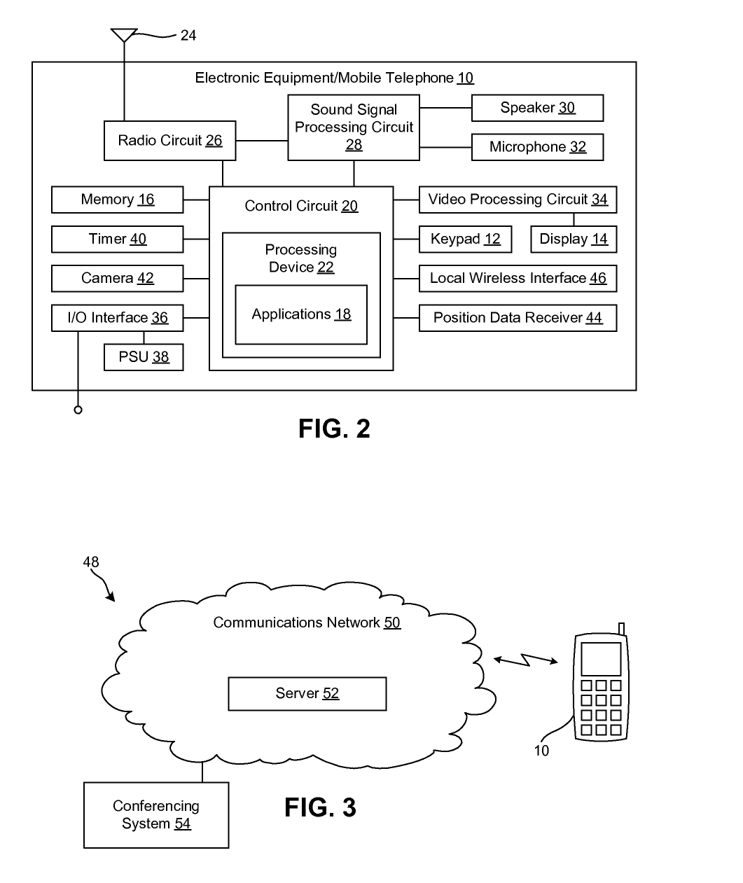

Referring initially to FIGS. 1 and 2, an electronic device 10 is shown. The electronic device 10 includes a keypad assembly 12. As will be described in greater detail below, the keypad assembly 12 provides for user input of alphanumeric characters and symbols (e.g., the pound and star symbols) as well as user control of the electronic device 10.

The electronic device of the illustrated embodiment is a mobile telephone and will be referred to as the mobile telephone 10. The mobile telephone 10 is shown as having a “brick” or “block” form factor housing, but it will be appreciated that other type housings, such as a clamshell housing or a slide-type housing, may be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 of the mobile telephone 10. The display 14 may be used to present images, video and other graphics to the user, such as photographs, mobile television content and video associated with games. In one embodiment, the display 14 may be touch sensitive to allow for user input to be entered by way of applying pressure to the surface of the display 14.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VOIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive and/or process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in a memory 16 and/or retrieving the data the memory 16, executing applications 18 to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as memory 16, in order to carry out operation of the mobile telephone 10. The memory 16 may be, for example, one or more of a buffer, a flash memory, a hard drive, a removable media, a volatile memory, a non-volatile memory or other suitable device.

In addition, the processing device 22 may execute code that implements the applications 18. The applications 18 may carry out various functions of the mobile telephone 10 as will be apparent to a person having ordinary skill in the art of computer programming, and specifically in application programming for mobile telephones or other electronic devices. Accordingly, details as to specific applications have been left out for the sake of brevity. Also, while the applications 18 are executed by the processing device 22 in accordance with a preferred embodiment of the invention, corresponding functionality could be carried out via dedicated hardware, firmware, software, or combinations thereof.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc. as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 18 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream received by the radio circuit 28 or obtained by any other suitable method.

The mobile telephone 10 further includes one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the IO interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 may also include a timer 40 for carrying out timing functions. Such functions may include timing the durations of calls, generating the content of time and date stamps, etc. The mobile telephone 10 may include a camera 42 for taking digital pictures and/or movies. Image and/or video files corresponding to the pictures and/or movies may be stored in the memory 16. The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF adaptor (e.g., a Bluetooth adapter), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 52 may be configured as a typical computer system used to carry out server functions and may include a processor configured to execute software containing logical instructions that embody the functions of the server 52.

With reference to FIGS. 1 and 4, the keypad assembly 12 will be described in greater detail. The keypad assembly 12 includes plural alphanumeric keys 56 for entering characters, such as numbers, letters and symbols (e.g., a star symbol and/or a pound symbol). In the illustrated embodiment, there are twelve alphanumeric keys 56. The alphanumeric keys 56 are associated with numbers zero through nine and with the star and pound symbols as is common for telephone keypads. The alphanumeric keys 56 associated with the numbers two through nine are also associated with letters from the English alphabet. As will be appreciated, the alphanumeric keys 56 may be associated with characters from other languages and/or other symbols. In other embodiments, there may be less than or more than twelve alphanumeric keys 56. For instance, a complement of alphanumeric keys 56 may be provided to establish a full QWERTY keypad.

In the illustrated embodiment, the alphanumeric keys 56 are relatively small. For instance, the alphanumeric keys 56 may be squares or rectangles having dimensions of about an eighth of an inch to about a half of an inch in either direction or, in another embodiment, about an eighth of an inch to about a quarter of an inch in either duration. The alphanumeric keys 56 need not be rectangular.

Each alphanumeric key 56 may be associated with surface indicia (e.g., printed characters or symbols) that correspond to the alphanumeric character(s) and/or symbols(s) for the alphanumeric key 56. In the illustrated example, surface indicia is disposed on a surface of the mobile telephone 10 adjacent each alphanumeric key 56. In other embodiments, such surface indicia may be disposed directly on the alphanumeric keys 56, or the surface indicia may be made from translucent material or opaque material surrounded by translucent material to facilitate backlighting.

The keypad assembly 12 also may include function keys 58. The function keys 58 may correspond to various tasks, such as launching a menu, answering a call, ending a call, controlling a camera, and so forth. Some function keys may have a single specific use and other function keys may have multiple uses that depend on an operational mode of the mobile telephone 10.

The function keys 58 may function as soft keys in conjunction with displayed icons, symbols or text shown on the display 14. For instance, in the illustrated embodiment, the function key 58a may serve as a call answer key and as a soft key for displayed indicia 60a (reading “more”). Similarly, the function key 58b may serve as an electronic mail or SMS function key and as a soft key for display indicia 60b (reading “select”). The function key 58c may serve as a call terminate key and as a soft key for displayed indicia 60c (reading “back”). Other illustrated function keys 58 include a volume and/or ringer mute key 58d and an additional pair of function keys 58e and 58f. In the illustrated embodiment, the call answer key 58a, the message function key 58b and the call terminate key 58c have surface indicia in the form of icons to assist the user in selecting an appropriate key for a desired function.

As indicated, the keypad assembly 12 also includes a navigation input device 62 (sometimes referred to as a direction input button). In the illustrated embodiment, the navigation input device 62 is configured as a “dome” switch. In the illustrated embodiment, the navigation input device 62 is configured to accept user inputs corresponding to an up direction, a down direction, a left direction and a right direction. However, the navigation device may be configured to accept fewer or more directional inputs including, for example, up-left, up-right, down-left and down-right.

In the illustrated embodiment, the navigation input device 62 has a user depressible member 64 that is configured to slightly rock in directions corresponding to the directional inputs accepted by the navigation input device 62 when force is applied to a perimeter region of the depressible member 64. Detents 66 may be disposed on the upper surface of the depressible member 64 or may be integrally formed with the depressible member 64 to provide the user with a tactile indication of where to press to indicate a desired directional input.

The keypad assembly 12 is illustrated only from above. However, one of ordinary skill in the art will understand how to construct an operable keypad assembly 12 in accordance with the features described herein. For instance, the keypad assembly 12 may be implemented using membrane switches disposed under the alphanumeric keys 56, the function keys 58 and the depressible member 64. When downward force is applied to any of the alphanumeric keys 56, the function keys 58 and/or the depressible member 64, the depressed key or member may activate a corresponding membrane switch to generate an input signal to the control circuit 20. The control circuit 20, in turn, executes logical instructions to carry out a specified action in accordance with the received input signal. For the navigation input device 62, a group of membrane switches may be arranged under the depressible member 64 so that the various directional inputs from the navigation input device 62 may be input by the user.

In operation, the navigation input device 62 may be used to specify cursor movement in text, specify movement to navigate through a menu, specify movement in connection with a game or specify other direction inputs to the mobile telephone 10. A select operation (e.g., to select a highlighted item on the display 14) may be carried out by use of a soft key. For instance, in the illustrated embodiment, the select operation is implemented with the function key 58b that behaves as a soft key in conjunction with displayed indicia 60b. Alternatively, a function key 58 that is dedicated to the select operation may be provided.

As indicated, the keypad assembly 12 combines one or more alphanumeric keys 56 and the multi-directional navigation input device 62 in a multipurpose (e.g., multifunction) portion of the keypad assembly 12. For instance, the one or more alphanumeric keys 56 and the navigation input device 62 may be commingled such that the alphanumeric key(s) 56 and the navigation input device 62 occupy the same area on the surface of the mobile telephone 10.

In the illustrated embodiment, to alphanumeric keys 56 are surrounded by the user depressible member 64 of the navigation input device 62. In this embodiment, the alphanumeric key 56 corresponding to the digit two and the alphanumeric key 56 corresponding to the digit five protrude through respective apertures in the depressible member 64. In this arrangement, the alphanumeric keys 56 that are commingled with the navigation input device 62 and the depressible member 64 may be operated independently of one another. Surface indicia (e.g., printed characters or symbols) that correspond to the alphanumeric character(s) and/or symbol(s) that are associated with the alphanumeric keys 56 that are commingled with the navigation input device 62 may be disposed on the depressible member 64. In other embodiments, an alphanumeric key or keys 56 other than the “two” key and the “five” key may be co-mingled with the navigation input device 62 and/or one or more function keys 58 may be co-mingled with the navigation input device 62. For example, a select key in addition to one or more alphanumeric keys 56 may be surrounded by the depressible member 64. U.S. Pat. No. 7,194,979, the disclosure of which is incorporated herein by reference in its entirety, discloses an example of how one may arrange a navigation input device with a key that protrudes through a center aperture in a depressible member of the navigation input device. In this patent, however, the key that protrudes through the depressible member is a select key or a function key and does not correspond to an alphanumeric key. In contrast, the illustrated embodiment of commingling one or more alphanumeric keys 56 with the navigation input device 62 advantageously reduces the area consumed by the alphanumeric keys 56 and the navigation input device 62 compared to the conventional approach of separating the alphanumeric keys 56 and the navigation input device 62.

In a different embodiment of the navigation input device 62, the depressible member 64 may be replaced by individual navigation keys where each navigation key corresponds to a specific direction. In this embodiment, the navigation input device 62 is the collection of individual navigation keys. The navigation keys in this embodiment may be commingled with alphanumeric keys 56. For instance, the navigation keys may be located in the same positions as the illustrated detents 66. Thus, in this embodiment, if one were to draw an imaginary line through at least some of the individual navigation keys to define an area, one or more alphanumeric keys 56 would be fully or at least partially disposed within the area. Similarly, if one were to draw an imaginary line through at least some of the alphanumeric keys 56 to define an area, one or more of the navigation keys would be fully or at least partially disposed within the area.

In yet another embodiment, the depressible member 64 may be replaced by a touch sensitive ring or rim that surrounds one or more of the alphanumeric keys 56.

In one embodiment, the alphanumeric keys 56, the function keys 58 and/or the navigation input device 62 may be backlit. For this purpose, a gap may be present between components so that illumination from a light source that is disposed within the mobile telephone 10 may visibly highlight desired components of the keypad assembly 12. The gap may or may not be filled with translucent material. For example, as shown in FIG. 4, translucent material 68 may surround the alphanumeric keys 56. In this embodiment, translucent material 68 is disposed between the depressible member 64 and the alphanumeric keys 56 that protrude through the depressible member 64. Translucent material 68 is also disposed between a housing panel 70 of the mobile telephone 10 and alphanumeric keys 56 that protrude through the housing panel 70. Similarly, translucent material 68 is also disposed between a housing panel 70 of the mobile telephone 10 and function keys 56 that protrude through the housing panel 70. In addition, translucent material 68 may surround the depressible member 64. Additional translucent material 68 may surround the detents 66. In one embodiment, the translucent material 68 may be integrated with the depressible member 64. In other embodiments, the alphanumeric keys 56, the function keys 58 and/or the depressible member 64 may be at least partially translucent.

As will be appreciated, a number of ways of layering navigation control with alphanumeric character entry to conserve space on a surface of the mobile telephone 10 have been described. The reduction in consumed space by the keypad 12 that commingles navigation control and alphanumeric character entry may be used for other components of the mobile telephone 10. For instance, the display 14 may be larger in area compared to a comparable display on a comparably sized mobile telephone that has navigation control separated from alphanumeric character entry. Alternatively, the overall size of the mobile telephone 10 may be reduced relative to a mobile telephone that has navigation control separated from alphanumeric character entry.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device, comprising a keypad assembly that includes:
a plurality of alphanumeric keys for user entry of alphanumeric characters; and
a navigation input device for user entry of plural directional inputs, the navigation input device and the alphanumeric keys being commingled such that an area consumed by at least one of the alphanumeric keys intersects with an area consumed by the navigation input device.

2. The electronic device of claim 1, wherein the navigation input device has a user depressible member that is depressible in locations corresponding to the plural directional inputs to accept entry of the directional inputs, and the alphanumeric key is at least partially surrounded by the depressible member.

3. The electronic device of claim 2, wherein the navigation input device includes an aperture through which the alphanumeric key protrudes.

4. The electronic device of claim 2, wherein plural alphanumeric keys protrude through corresponding apertures of the depressible member.

5. The electronic device of claim 2, wherein surface indicia corresponding to the alphanumeric key is disposed on the depressible member.

6. The electronic device of claim 2, wherein the electronic device is a mobile telephone having a radio circuit to establish a call over a communications network.

7. The electronic device of claim 2, wherein the keypad assembly further includes a select key for user entry of a select command.

8. The electronic device of claim 7, wherein the select key is one of a function key or a soft key.

9. The electronic device of claim 7, wherein the select key is located apart from the navigation input device.

10. The electronic device of claim 7, wherein the select key is commingled with the navigation input device.

11. The electronic device of claim 1, wherein the navigation input device is a collection of navigation keys and wherein each navigation key corresponds to one of the directional inputs and at least some of the navigation keys are interspersed with the alphanumeric keys.

12. The electronic device of claim 11, wherein the electronic device is a mobile telephone having a radio circuit to establish a call over a communications network.

13. The electronic device of claim 11, wherein the keypad assembly further includes a select key for user entry of a select command.

14. An electronic device, comprising a keypad assembly including:
a navigation input device having a user depressible member that is depressible in a plurality of locations, each location corresponding to a directional input; and
plural keys that are at least partially surrounded by the user depressible member so that the keys and the navigation input device are commingled such that an area consumed by the keys intersects with an area consumed by the navigation input device.

15. The electronic device of claim 14, wherein at least one of the keys is an alphanumeric key.

16. The electronic device of claim 14, wherein at least on of the keys is a select key.

17. The electronic device of claim 14, wherein the electronic device is a mobile telephone having a radio circuit to establish a call over a communications network.
